(19) United States
(12) Patent Application Publication
(10) Pub. No.: US 2002/0012774 A1
(43) Pub. Date: Jan. 31, 2002

(54) Water-based, water resistant ink jet media

(76) Inventors: William A. Neithardt, Ridgefield, NJ (US); Qiping Zhong, Cupertino, CA (US)

Correspondence Address: Ronald W. Citkowski, Gifford, Krass, Groh, Sprinkle, Anderson & Citkowski, P.C., 280 N. Old Woodward Ave., Suite 400, Bermingham, MI, 48009, US

(21) Appl. No.: 09/859,606

(22) Filed: May 17, 2001

Related U.S. Application Data
(60) Provisional application No. 60/205,815, filed on May 19, 2000.

(51) Int. Cl. B41M 5/00

(52) U.S. Cl. 428/195

(57) ABSTRACT

An ink jet imaging medium comprises polyvinyl alcohol, a latex, a dye mordant, and a water absorbing pigment. The coating can be prepared from a water-based solvent system, and the medium is receptive of solvent-based and water-based inks.

### RELATED APPLICATION

This patent application claims priority of provisional patent application Ser. No. 60/205,815 filed May 19, 2000, and entitled “Water-Based, Water Resistant Ink Jet Media.”

### FIELD OF THE INVENTION

The present invention relates to ink jet printing media, more particularly to an aqueous based coating composition for preparing a water resistant, ink receiving ink jet imaging medium.

### BACKGROUND OF THE INVENTION

Printers using sprayable inks, such as ink jet printers, are becoming increasingly common. These printers utilize a small aperture to selectively propel ink in response to a series of electronic commands. Ink jet printers are characterized by high speed and simple operation, making them further adaptable to the use of multiple color/multiple composition inks for computer graphics applications.

With ever increasing demands for print quality, ink jet media, the surfaces onto which the printer applies the ink, have become ever more sophisticated in order to meet image quality requirements. Ink jet printed images are expected to have high pixel and color densities as well as being smudge resistant and, to a large extent, archival. In order to meet these requirements, an ink jet medium should readily absorb sprayed ink so as to retain the dimensions of the original ink spot; dry with sufficient speed under normal printing conditions to allow an overlapping ink spot to be applied without bleeding or other deleterious interaction between the two spots; appear optically bright; be water resistant and be resistant to curl and delamination throughout the printing process.

Various coating compositions for the preparation of ink jet media are well known, and are generally characterized as being either solvent based or aqueous based; and it is understood that aqueous based coatings can include lesser amounts of hydrophilic, low vapor pressure solvents such as pyrrolidones, glycols, glycol ethers and the like. As concern about VOCs increase, the use of organic solvents in the manufacture of ink jet compositions is under ever increasing control and scrutiny. Consequently, the industry is turning to aqueous coating chemistries.

Also, the industry is turning to the use of aqueous inks for ink jet imaging. Therefore, there is a need for an ink jet medium which can be coated from an aqueous solvent system; but which is capable of being imaged with aqueous inks. Since, in some instances, solvent-based inks (including pigment- containing inks as well as dye-based inks) are used for ink jet imaging, the medium should also be capable of accepting such inks. Also, such ink jet media must retain inks disposed thereon after exposure to water.

Ink jet media including a support and an ink receiving layer are known to the art. Ink receiving layers or coatings have previously included polyvinylalcohol, polyvinylpyrrolidone homopolymer and/or vinylpyrrolidone copolymer, and a water soluble substance containing aldehyde groups. U.S. Pat. No. 5,569,529 is representative thereof. However, prior art media are not able to address all of the issues and requirements which allow a fully aqueous preparation and use to be implemented. As will be explained in detail hereinbelow, the present invention provides for an ink jet imaging medium which can be prepared and used in accord with aqueous chemistries, but which will also accept solvent-based inks.

### BRIEF DESCRIPTION OF THE INVENTION

There is disclosed herein a coating formulation for an ink jet medium. The coating is comprised of, on a weight basis, 20-27% polyvinylalcohol; 10-14% of a latex material; 1-5% of a dye mordant; and 25-35% of a water absorbing pigment. This composition may further include an optical brightener, typically in an amount of 0.1-2 weight percent. Some preferred dye mordants comprise cationic polymers, polyamines, quaternary ammonium compounds, and combinations thereof. In specific embodiments, the latex comprises a styrene butadiene latex.

Also disclosed herein is an ink jet imaging medium which is comprised of a substrate, which may be paper, polymer, or the like; wherein the substrate has an ink receiving layer disposed thereupon. The ink receiving layer is, in this embodiment, present at a coating density in the range of 15-30 grams per meter squared, and it is comprised of a polyvinylalcohol, a latex component, a dye fixative mordant, and a water absorbing pigment. Also disclosed herein is a method for making an ink jet medium which comprises coating a substrate with a water-based mixture of polyvinylalcohol, a latex component, a dye fixant mordant, and a water absorbing pigment. The coating is dried so as to remove the water therefrom. In one specific embodiment of the invention, this drying is carried out by contacting the coated surface of the substrate with a highly polished, heated cylinder so as to produce a highly glossy coating on the substrate.

### DETAILED DESCRIPTION OF THE INVENTION

The ink jet media of the present invention are based upon aqueous coatings which dry to form a gel layer. The ink receiving layer/coating formulations employed in the practice of the present invention include aqueous, gel forming polymer mixtures containing a polyvinylalcohol and a latex component, preferably a styrene butadiene latex such as Dow Latex RAP 456 and a dye fixative mordant such as a cationic polymer, polyamine, or quaternary ammonium compound. The dye fixative mordant can comprise any fixative known in the art, which is compatible with the remaining ingredients of the coating. Some preferred fixatives include Lasso Fix FRN-300HI CONC; Lasso Fix TW both from Hoechst Celanese, Charlotte, N.C., and Texor Fix R-CONC; Texor Fix XP-5157; Texor Fix XP-5150; and Texor Fix PC-CONC, all from Ortec, Inc., Easley, S.C. Quaternary alkyl ammonium polymers such as poly(dimethyl diethyl ammonium chloride) are one preferred group of mordants.

A preferred class of polyvinylalcohol are the partially hydrolyzed alcohols, where between 85 and 95% hydrolysis has occurred. It is appreciated that fully hydrolyzed polyvinylalcohol is also operative in the present invention. The ink receiving layer/coating formulation further contains a water absorbing pigment, such as silica, silicic acid, clay, conventional inorganic pigments and zeolites. Other additives optionally included in the ink receiving layer/coating formulation are: dyes, dispersants, surfactants, and optical brighteners.

The polyvinylalcohol is preferably present in amounts ranging from, by weight, approximately 21-27%, the latex component is preferably present in amounts ranging from approximately 10-14%, the water is preferably present in amounts ranging from approximately 25-35%, the dye mordant is preferably present in amounts ranging from approximately 1-5%, the water absorbing pigment is preferably present in amounts ranging from approximately 25-35%, and other additives or components, such as an optical brightener, are present in amounts ranging from 0-2%. Other broader ranges are contemplated in the present invention.

The formulation of the ink receiving layer/coating of the present invention can be applied to a paper and/or polymeric substrate including polyethylene, polypropylene, and polyvinyl chloride or polymer coated paper substrates. The formulation of the ink receiving layer of the present invention can optionally be applied to a hydrophobic barrier layer, disposed on the substrate. The barrier layer is between the substrate and the ink receptor layer of the present invention and is of sufficient thickness and composition to prevent an aqueous dye ink, such as those employed by conventional ink jet printers, from penetrating therethrough.

The barrier layer is a hydrophobic polymeric material such as a polyalkene, polyester, polyether or the like. Preferably, the barrier layer is composed of polyethylene. The barrier layer may be extruded onto the supporting substrate to form a comparatively thick layer or alternatively, is applied as a thin coating onto the substrate. The preferred barrier layer coat weight for an extruded layer is from 10 grams per square meter to 30 grams per square meter whereas for a thin coated barrier layer the coat weight is from 3 grams per square meter to 10 grams per square meter. Preferably, the back side of the supporting substrate has an additional barrier layer applied thereto. Optionally, an additional ink receiving layer/coating is applied to the back side barrier layer.

In addition to the barrier layer, further back coats may optionally be employed, either between the substrate and barrier layer or on the back side of the substrate opposite the ink receptive layer. Such coatings are known in the art, and are used, for example, to improve curl resistance and lamination properties or to impart adhesive properties.

The ink receiving layer/coating formulation is spread onto the substrate and/or the barrier layer so as to achieve a dry coating weight of between 15 grams per square meter and 30 grams per square meter. Preferably, the dry coating weight of the ink receiving layer/coating formulation is between 20 grams per square meter and 25 grams per square meter.

In one preferred coating process, the ink receiving layer/coating is first applied or cast onto the substrate (which may optionally include a barrier layer or other auxiliary coatings as discussed above). The coating is applied by any well known technique such as wire bar coating, blade coating or the like. The coating is then dried onto the layer by using a highly polished, heated cylinder in a process similar to the photofinishing technique known as ferrotyping. This process produces a gloss coating on the substrate like that of photographic papers. The cylinder is heated to a temperature between approximately 100 and 120° C. and the coated substrate is exposed to the heated cylinder for approximately thirty seconds to two minutes to achieve suitable drying of the coating. Additionally, when this process is used to dry the coating to the substrate, the solids content of the ink receiving layer/coating is increased to approximately twenty-five to thirty percent by decreasing the amount of water in the mixture. Other techniques known to those skilled in the art could also be used to apply the ink receiving layer/coating to the substrate and/or barrier layer.

The invention is illustrated in greater detail in the following examples which are intended only to illustrate the invention and not in any way limit the scope of the appended claims. Unless otherwise noted, the percentages therein and throughout the application are by weight.

### EXAMPLES

### Example 1

A first coating composition in accord with the present invention was prepared from the following ingredients, and all percentages given herein are on the basis of weight:

| | |
|---|---|
| Water | 56.2 |
| Dye fixative (XP5157) | 2.9 |
| Silica (Syloid ® W300) | 4.7 |
| Polyvinyl alcohol (10% solution Airvol ® 165) | 23.9 |
| Latex (Dow 456) | 11.2 |
| Optical brightener (Lucophor ® L) | 1.1 |

In this composition, the latex material comprises a styrene-butadiene polymer, and the dye mordant comprises a polyacrylate.

### Example 2

Another formulation in accord with the present invention comprises, on a weight basis:

| | |
|---|---|
| Water | 64.5 |
| Dye fixer (Agefloc A50HV-P) | 2.8 |
| Triethanolamine (AMP 95) | 0.1 |
| Silica (Syloid ® 221) | 9.6 |
| Polyvinylalcohol (Airvol ® 523) | 16.7 |
| Latex (Airflex ® 110) | 4.8 |
| Surfactant (Triton ® 100) | 0.1 |
| Optical brightener (Blankophor ® TX) | 1.4 |

The dye fixer in this embodiment comprises a quaternary cationic polymer, specifically poly(dimethyl diethyl ammonium chloride). The latex is a vinyl ethylene emulsion, and the amine is used to adjust the pH so as to stabilize the emulsion.

### Example 3

Another formulation in accord with the present invention comprises, on a weight percent basis:

| | |
|---|---|
| Water | 62.9 |
| Dye fixer (Agefloc A50HV-P) | 2.7 |
| Triethanolamine (AMP 95) | 0.1 |
| Silica (Syloid ® 221) | 9.4 |
| Polyvinylalcohol (Airvol ® 523) | 16.3 |
| Latex (Airflex ® 110) | 7.1 |
| Surfactant (Triton ® 100) | 0.1 |
| Optical brightener (Blankophor ® TX) | 1.4 |

Still other formulations may be prepared in accord with the present invention. For example, it has been found that the polyvinylalcohol and/or the latex components can be increased by 50%, and the medium will still maintain desirable ink jet imaging and thermal laminating properties. Also, while certain materials have been disclosed herein, yet other materials may be substituted therefore by one of skill in the art. Likewise, ancillary ingredients such as coloring agents, texturing agents and the like may be readily incorporated into the compositions of the present invention.

The composition of the present invention can be coated onto a variety of substrates including polymers such as PET, polypropylene and the like. The compositions can also be coated onto paper. As is known in the art, subcoatings and adhesion layers may be employed to facilitate the use of various substrates. A release layer may also be disposed on the subcoatings or adhesion layer to protect the layer and also to prevent premature adhesion thereby forming, for example, label stock. The compositions of the present invention are most preferably used for ink jet imaging, but can also be employed for other uses where a water-resistant, ink-receptive surface is required. The formulation and media of the present invention can be employed for use in exterior displays as a substitute for expensive vinyl stock.

There will be various modifications, improvements and applications of the disclosed invention that will be apparent to those skilled in the art, and the present application is intended to cover such embodiments. Although the present invention has been described in the context of certain preferred embodiments, it is intended that the full scope of these be measured by reference to the scope of the following claims.

1. A coating formulation for an ink jet medium, said coating comprising:
from 20 to 27 total weight percent of polyvinylalcohol;
from 10 to 14 total weight percent latex component;
from 1 to 5 total weight percent dye mordant;
from 25 to 35 total weight percent of a water absorbing pigment; and
an aqueous solvent.

2. The coating formulation of claim 1 further comprising an optical brightener.

3. The coating formulation of claim 2, wherein optical brightener is present from 0.1 to 2 total weight percent.

4. The ink receiving coating formulation of claim 1, wherein said water absorbing pigment comprises silica.

5. The coating formulation of claim 1, wherein said dye mordant is selected from the group consisting of a cationic polymer, a polyamine, a quaternary ammonium compound, and combinations thereof.

6. The coating formulation of claim 5, wherein said quaternary ammonium compound comprises an alkyl ammonium salt.

7. The coating formulation of claim 1, wherein said latex comprises a styrene-butadiene latex.

8. An ink jet medium comprising:
a substrate; and
an ink receiving layer disposed upon said substrate, said ink receiving layer having a coating density in the range of 15 to 30 grams per meter squared, said ink receiving layer comprising: a polyvinylalcohol, a latex component, a dye fixative mordant, and a water absorbing pigment.

9. The ink jet medium of claim 8 further comprising a barrier layer interposed between said substrate and said ink receiving layer.

10. The ink jet medium of claim 9 wherein said barrier layer has a density from approximately 3 to 30 grams per meter squared.

11. The ink jet medium of claim 10 wherein said barrier layer density is from approximately 3 to 10 grams per meter squared.

12. The ink jet medium of claim 8 wherein the ink receiving layer density is from 20 to 25 grams per meter squared.

13. The ink jet medium of claim 8, wherein said dye mordant is selected from the group consisting of a cationic polymer, a polyamine, and a quaternary ammonium compound.

14. The ink jet medium of claim 8, wherein said latex component comprises a styrene-butadiene latex.

15. A method for making an ink jet medium, said method comprising the steps of:
providing a substrate having a first and a second surface;
disposing an ink receiving coating on the first surface, the ink receiving coating comprising a water-based mixture of: a polyvinylalcohol, a latex component, a dye fixative mordant, and a water absorbing pigment.

16. The method of claim 15, including the further step of: drying the coated surface of the substrate by contacting the coated surface of the substrate with a highly polished, heated cylinder to produce a highly glossy coating on the substrate.

17. A method according to claim 16, wherein the cylinder is heated to a temperature ranging from approximately 100° C. to approximately 130° C.

18. A method according to claim 15, wherein the coated surface of the substrate is heated for between approximately thirty seconds and approximately two minutes.
